(19) United States
(12) Patent Application Publication
(10) Pub. No.: US 2015/0060211 A1
(43) Pub. Date: Mar. 5, 2015

(54) FALL PREVENTION DEVICE FOR AN ELEVATOR

(71) Applicant: CHING-FENG CHOU, KAOHSIUNG CITY (TW)

(72) Inventor: CHING-FENG CHOU, KAOHSIUNG CITY (TW)

(21) Appl. No.: 14/013,191

(22) Filed: Aug. 29, 2013

(51) Int. Cl. B66B 13/00; B66B 5/00

(52) U.S. Cl. CPC B66B 13/00; B66B 5/00
USPC 187/336

(57) ABSTRACT

A fall prevention device includes a shaft extending vertically through a multi-story building. A door is provided on each floor of the multi-story building. A cab is movably mounted in the shaft and includes a cab door. A movement device includes a power mechanism and first and second grid structures directly or indirectly connected to the power mechanism. The first and second grid structures are respectively fixed to top and bottom sides of the cab at locations adjacent to the cab door. Each of the first and second grid structure includes a plurality of rails spaced from each other in a width direction perpendicular to the vertical direction. The movement device further includes a first support device in a top end of the shaft and a second support device in a bottom end of the shaft. The first and second support devices respectively support the first and second grid structures.

### BACKGROUND OF THE INVENTION

The present invention relates to a fall prevention device for an elevator and, more particularly, to a fall prevention device preventing entrance into a cab of an elevator not at a correct floor position.

Elevators are a convenient tool for transporting people, goods, or cars in a multi-story building or elevated site. An elevator generally includes a shaft extending vertically through a plurality of floors, with a door provided on each floor. The elevator includes a cab movable in the shaft. When the cab reaches the desired floor position, a cab door of the cab is aligned with the door on the floor and opens to allow entry of people, goods, or a car. Ascending and descending of the cab to the desired floor position, opening/closing of the doors and the cab door, and lamp indicators indicating the location of the cab are generally controlled by delicate detection and control of many components. Safety devices including brakes have been provided to avoid casualties resulting from unexpected falling of the cab.

However, an accident can still happen in a scenario shown in FIG. 7. Namely, the door 41 on a floor opens without the cab 42 (and its cab door 421) present to enter into. When the door 41 opens, casualties occur if a person or goods or a car moves in a hurry without checking the position of the cab 42. For example, a person would fall into the shaft 43 and be injured or even die. The tragedy often results from malfunction of the components. However, safety risks still exist no matter delicate control and surveillance and high-level safety devices are provided.

Thus, a need exists for a novel fall prevention device for an elevator for reliably preventing casualties even if the cab is not at a correct floor position.

### BRIEF SUMMARY OF THE INVENTION

A fall prevention device according to the present invention includes a shaft adapted to extend vertically through a multi-story building in a vertical direction, with the multi-story building including a plurality of floors. A door is adapted to be provided on each of the plurality of floors. A cab is movably mounted in the shaft and includes a cab door. A movement device includes a power mechanism and first and second grid structures directly or indirectly connected to the power mechanism. The first grid structure has a first end fixed to a top side of the cab at a location adjacent to the cab door. The second grid structure has a first end fixed to a bottom side of the cab at a location adjacent to the cab door. Each of the first and second grid structure includes a plurality of rails spaced from each other in a width direction perpendicular to the vertical direction. The movement device further includes a first support device in a top end of the shaft and a second support device in a bottom end of the shaft. The first and second support devices respectively support the first and second grid structures.

In a case that the door is opened but the cab is not at the correct floor position, the door is aligned with the first or second grid structure even though the door is not aligned with the cab door of the cab. The first or second grid structure provides a warning effect to a user intended to use the cab.

In an example, a second end of the first grid structure is integrally connected with a second end of the second grid structure. The power mechanism is an elevating mechanism for moving the cab in the shaft in the vertical direction. Movement of the cab in the vertical direction causes reciprocal movement of the first and second grid structures in an annular path. The first support device includes a plurality of first guiding rollers arranged in the width direction. The first support device further includes a plurality of second guiding rollers respectively aligned with the plurality of first guiding rollers. The second support device includes a plurality of third guiding rollers arranged in the width direction. The second support device further includes a plurality of fourth guiding rollers respectively aligned with the plurality of third guiding rollers.

In another example, the power mechanism includes an upper reel rotatably mounted in the upper end of the shaft and a lower reel rotatably mounted in the lower end of the shaft. The first grid structure has a second end fixed to the upper reel. The second grid structure has a second end fixed to the lower reel. The upper reel includes a spool forming the first support device. The lower reel includes a spool forming the second support device.

Each rail of the first and second grid structures can be formed by a metal cable, a cloth rope, a belt, or a chain.

The present invention will become clearer in light of the following detailed description of illustrative embodiments of this invention described in connection with the drawings.

### DESCRIPTION OF THE DRAWINGS

FIG. 1 is a perspective view of an elevator with a fall prevention device according to the present invention.

FIG. 2 is a schematic side view illustrating a building in which the elevator of FIG. 1 is mounted, with a cab door of a cab of the elevator opened and aligned with an opened door on a floor of the building.

FIG. 3 is a schematic cross sectional view of the building and the elevator of FIG. 2.

FIG. 4 is a schematic side view similar to FIG. 2, with the cab door of the cab opened but not aligned with the opened door of the floor.

FIG. 5 is a schematic cross sectional view of the building and the elevator of FIG. 4.

FIG. 6 is a view similar to FIG. 5, illustrating another example of the elevator according to the present invention, with the cab door of the cab opened but not aligned with the opened door on a floor.

FIG. 7 is a schematic cross sectional view of a conventional elevator, illustrating an accident resulting from a cab door of a cab not aligned with an opened door on a floor.

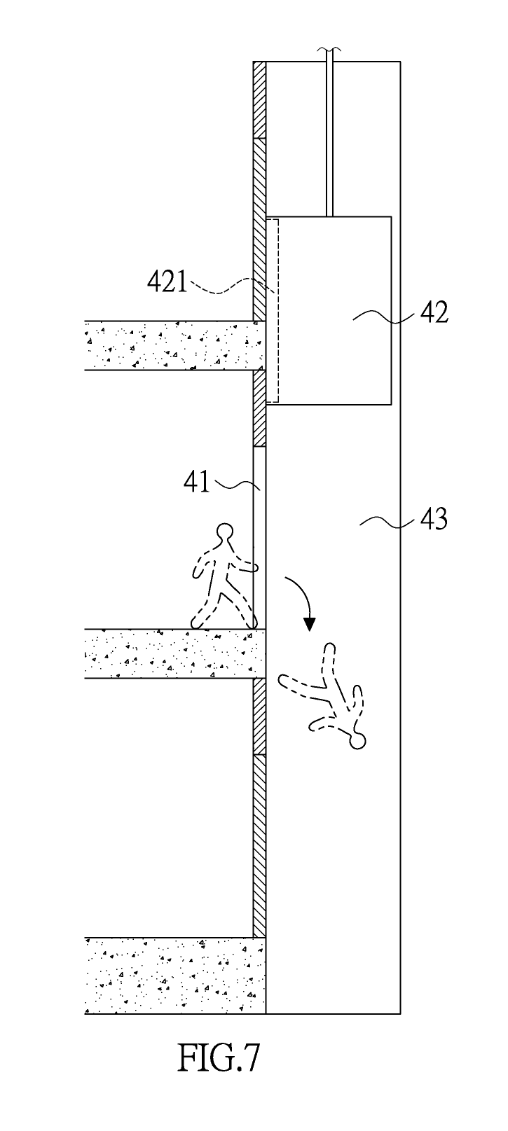

### DETAILED DESCRIPTION OF THE INVENTION

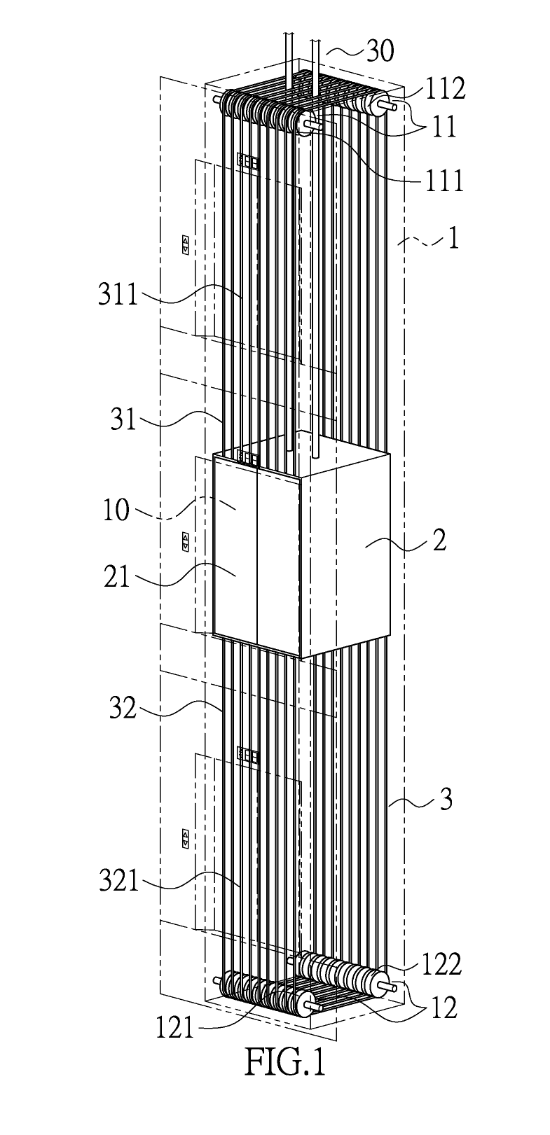

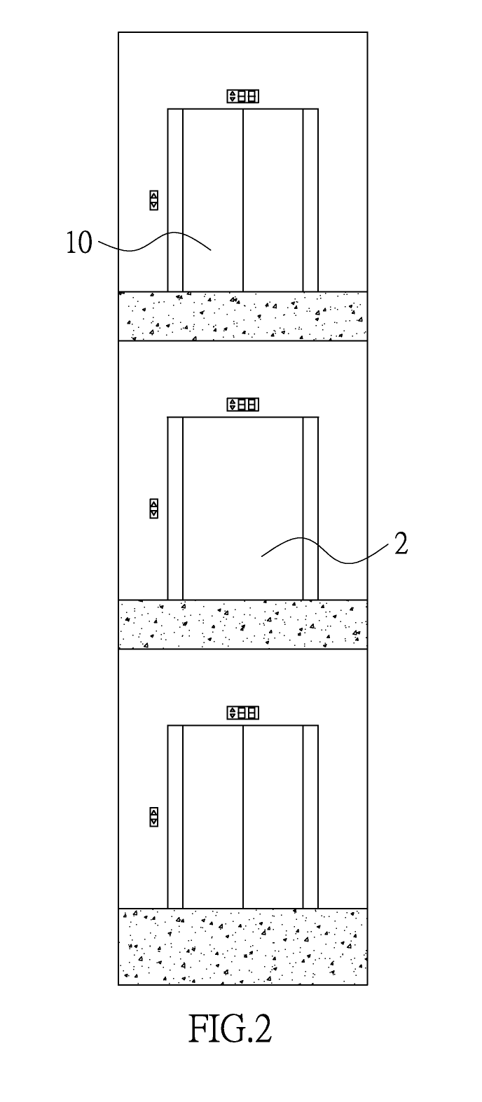

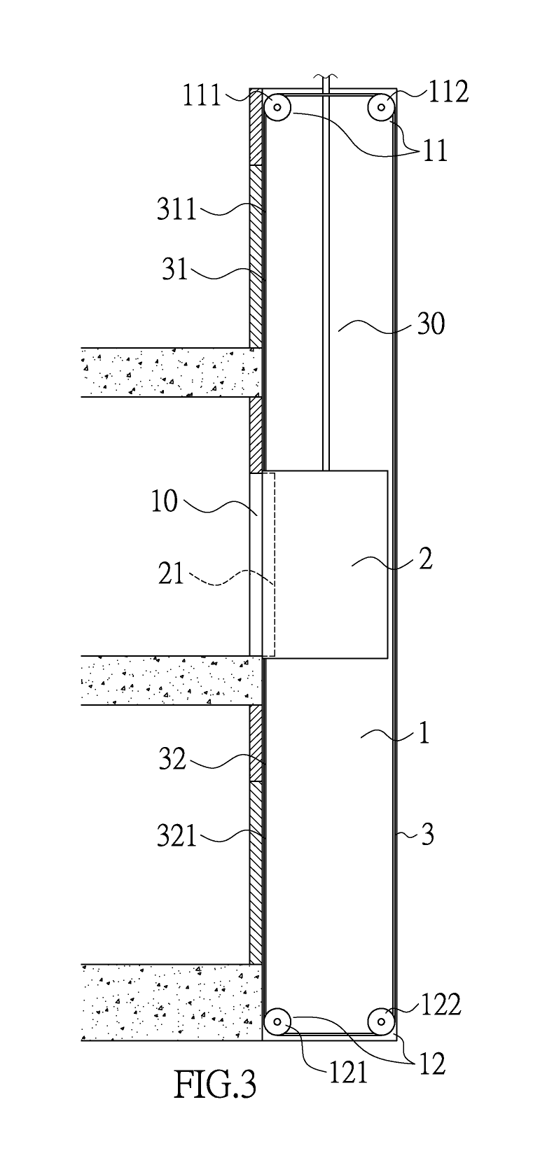

With reference to FIGS. 1-3, a fall prevention device for an elevator according to the present invention includes a shaft 1 adapted to extend vertically through a multi-story building in a vertical direction, with the multi-story building including a plurality of floors. A door 10 is adapted to be provided on each floor.

A cab 2 is movably mounted in the shaft 1 and includes a cab door 21. A movement device 3 includes a power mechanism 30 and first and second grid structures 31 and 32 directly or indirectly connected to the power mechanism 30. The first grid structure 31 has a first end fixed to a top side of the cab 2 at a location adjacent to the cab door 21. The second grid structure 32 has a first end fixed to a bottom side of the cab 2 at a location adjacent to the cab door 21. Each of the first and second grid structure 31 and 32 includes a plurality of rails 311, 321 spaced from each other in a width direction perpendicular to the vertical direction. Preferably, each rail 311, 321 of the first and second grid structures 31 and 32 is formed by a metal cable, a cloth rope, a belt, or a chain and can be selected according to needs.

The movement device 3 further includes a first support device 11 in a top end of the shaft 1 and a second support device 12 in a bottom end of the shaft 1. The first and second support devices 11 and 12 respectively support the first and second grid structures 31 and 32.

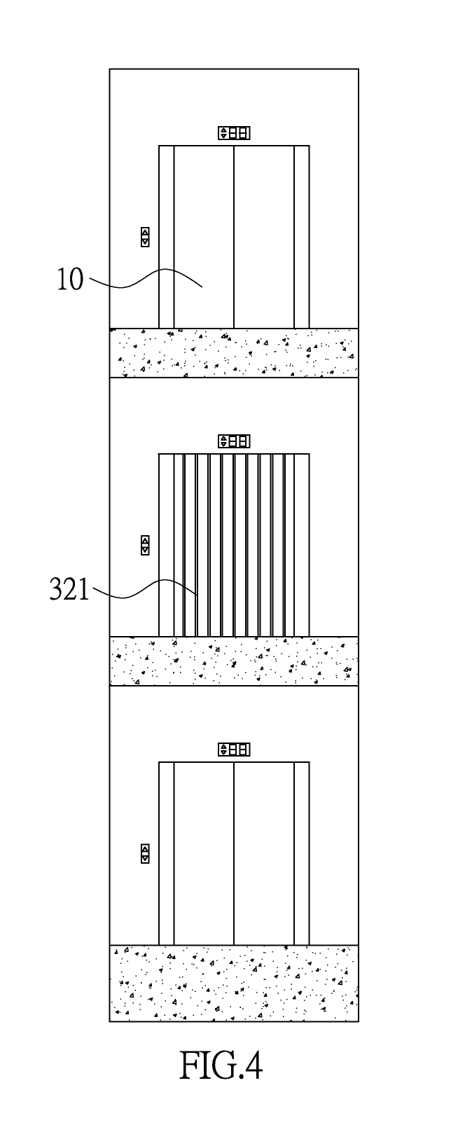

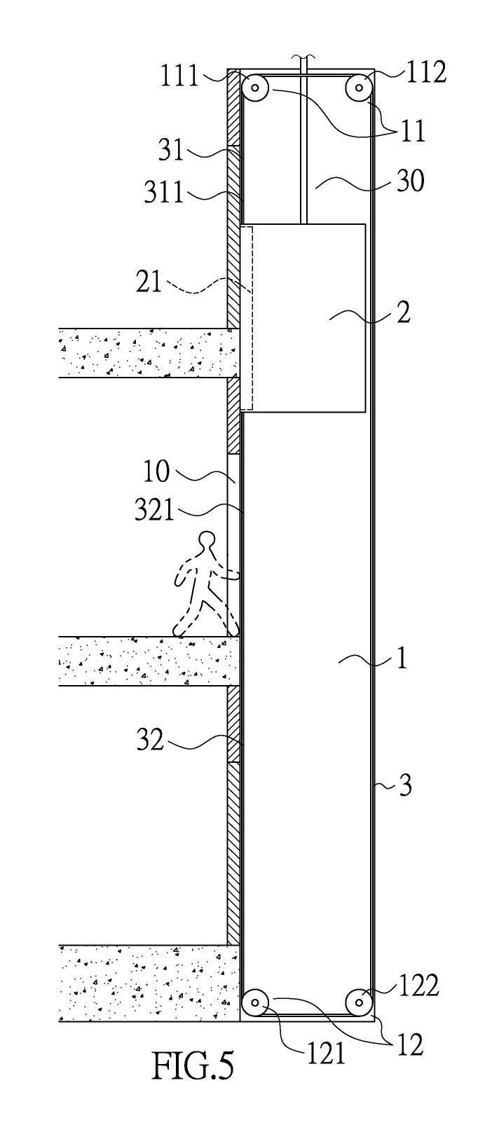

With reference to FIGS. 4 and 5, in a case that the door 10 is opened but the cab 2 is not at the correct floor position, the door 10 is aligned with the first or second grid structure 31, 32 even though the door 10 is not aligned with the cab door 21 of the cab 2. The first or second grid structure 31, 32 provides a warning effect to a user intended to use the cab 2. The first and second grid structures 31 and 32 can be painted with fluorescent paint, reflective paint, or eye-catching paint to enhance the warning effect such that the user would hesitate at the sight of the first or second grid structure 31, 32, reducing the risks of moving towards the first or second grid structure 31, 32 and falling into the shaft 1.

Even if the user, a car, or goods move towards the door 10, the user, car, or goods will be stopped by the first or second grid structure 31, 32, providing a reliable fall prevention effect. The spacing between rails 311, 321 can be adjusted according to actual operation and installation to reliably prevent the user, car, or goods from falling into the shaft 1.

In the example shown in FIGS. 1-5, the second end of each of the first and second grid structures 31 and 32 is integrally connected with the second end of the second grid structure 32. Furthermore, the power mechanism 30 is an elevating mechanism for moving the cab 2 in the shaft 1 in the vertical direction. Movement of the cab 2 in the vertical direction causes reciprocal movement of the first and second grid structures 31 and 32 in an annular path. The first support device 11 includes a plurality of first guiding rollers 111 arranged in the width direction. The first support device 11 further includes a plurality of second guiding rollers 112 respectively aligned with the first guiding rollers 111. Each rail 311 of the first grid structure 31 is wound around one of the first guiding rollers 111 and one of the second rollers 112, providing a stable support for the first grid structure 31. Even if the cab 2 is out of control and falls, the first grid structure 31 provides an auxiliary braking effect. The second support device 12 includes a plurality of third guiding rollers 121 arranged in the width direction. The second support device 12 further includes a plurality of fourth guiding rollers 122 respectively aligned with the third guiding rollers 121. Each rail 321 of the second grid structure 32 is wound around one of the third guiding rollers 121 and one of the fourth rollers 122, providing a stable support for the second grid structure 32. Even if the cab 2 is out of control and falls, the second grid structure 32 provides an auxiliary braking effect.

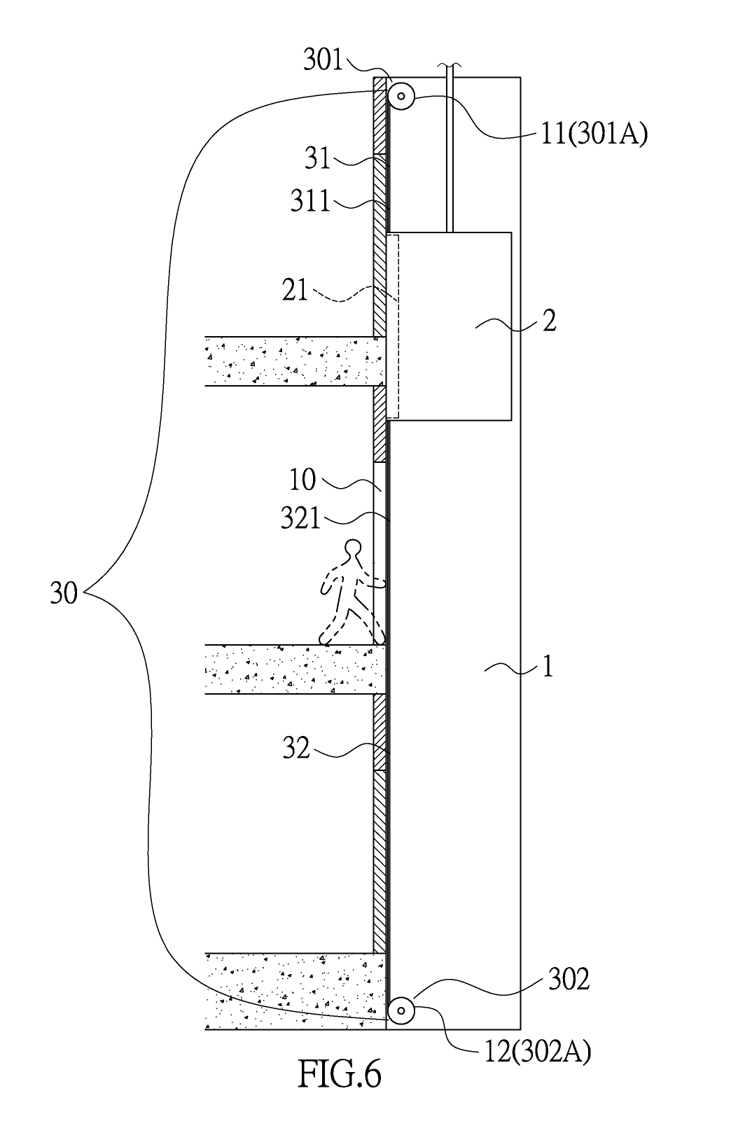

In another example shown in FIG. 6, the power mechanism 30 includes an upper reel 301 rotatably mounted in the upper end of the shaft 1 and a lower reel 302 rotatably mounted in the lower end of the shaft 1. The second end of the first grid structure 31 is fixed to the upper reel 301. The second grid structure 32 is fixed to the lower reel 302. The upper reel 301 includes a spool 301A forming the first support device 11, and the lower reel 302 includes a spool 302A forming the second support device 12. Thus, the first and second grid structures 31 and 32 can reciprocatingly move in an annular path.

Although specific embodiments have been illustrated and described, numerous modifications and variations are still possible without departing from the scope of the invention. The scope of the invention is limited by the accompanying claims.

1. A fall prevention device for an elevator comprising:
a shaft adapted to extend vertically through a multi-story building in a vertical direction, with the multi-story building including a plurality of floors, with a door adapted to be provided on each of the plurality of floors;
a cab movably mounted in the shaft and including a cab door; and
a movement device including a power mechanism and first and second grid structures directly or indirectly connected to the power mechanism, with the first grid structure having a first end fixed to a top side of the cab at a location adjacent to the cab door, with the second grid structure having a first end fixed to a bottom side of the cab at a location adjacent to the cab door, with each of the first and second grid structure and including a plurality of rails spaced from each other in a width direction perpendicular to the vertical direction, with the movement device further including a first support device in a top end of the shaft and a second support device in a bottom end of the shaft, with the first and second support devices respectively supporting the first and second grid structures.

2. The fall prevention device for an elevator as claimed in claim 1, with each of the first and second grid structures having a second end, with the second end of the first grid structure integrally connected with the second end of the second grid structure, with the power mechanism being an elevating mechanism for moving the cab in the shaft in the vertical direction, with movement of the cab in the vertical direction causing reciprocal movement of the first and second grid structures in an annular path.

3. The fall prevention device for an elevator as claimed in claim 1, with the power mechanism including an upper reel rotatably mounted in the upper end of the shaft and a lower reel rotatably mounted in the lower end of the shaft, with the first grid structure having a second end fixed to the upper reel, with the second grid structure having a second end fixed to the lower reel, with the upper reel including a spool forming the first support device, with the lower reel including a spool forming the second support device.

4. The fall prevention device for an elevator as claimed in claim 2, with the first support device including a plurality of first guiding rollers arranged in the width direction, with the first support device further including a plurality of second guiding rollers respectively aligned with the plurality of first guiding rollers.

5. The fall prevention device for an elevator as claimed in claim 4, with the second support device including a plurality of third guiding rollers arranged in the width direction, with the second support device further including a plurality of fourth guiding rollers respectively aligned with the plurality of third guiding rollers.

6. The fall prevention device for an elevator as claimed in claim 1, with each of the plurality of rails of the first and second grid structures being formed by a metal cable, a cloth rope, a belt, or a chain.
